(19) United States
(12) Patent Application Publication
(10) Pub. No.: US 2008/0273770 A1
(43) Pub. Date: Nov. 6, 2008

(54) Fast Fingerprint Identification And Verification By Minutiae Pair Indexing

(75) Inventor: Petr Kohout, Roztoky (CZ)

Correspondence Address: JAS IP CONSULTING, 309 2nd STREET, SUITE 8, LOS ALTOS, CA, 94022, US

(73) Assignee: UPEK, INC., Emeryville, CA (US)

(21) Appl. No.: 12/112,122

(22) Filed: Apr. 30, 2008

Related U.S. Application Data
(60) Provisional application No. 60/915,756, filed on May 3, 2007.

(51) Int. Cl. G06K 9/00

(52) U.S. Cl. 382/125

(57) ABSTRACT

For each minutia in the fingerprint, a set of surrounding “neighborhood” minutiae is identified. In each neighborhood, each minutiae pair of central and neighboring minutiae is described by several features including (but not limited to) the spacing between the two minutiae in a pair, the difference of orientations of two minutiae and the angle between the orientation of the central minutia and a line connecting the two minutiae. From these minutiae pair features, a minutiae pair index is constructed. The minutiae pair indices of enrolled fingerprints are compared to those of a proffered fingerprint. Identification of match can be by way of sufficient matching indices, sufficient matching neighborhoods identified from matching indices, and can be verified by a detailed comparison of corresponding minutiae pairs.

### CROSS REFERENCE TO RELATED APPLICATIONS

The present disclosure relates to U.S. provisional patent application Ser. No. 60/915,756, titled “Fast Fingerprint Identification And Verification By Minutiae Pair Indexing”, filed May 3, 2007, which is incorporated by reference herein and to which priority is hereby claimed.

### BACKGROUND OF THE INVENTION

The present invention is related to biometric sensing and identification, and more specifically to methods and apparatus providing improvement in speed of scalable fingerprint identification and verification.

The following documents describe certain aspects of the prior art, each document being incorporated by reference herein: U.S. Pat. No. 7,206,437 to Kramer et al., titled “Method To Conduct Fingerprint Verification And A Fingerprint Verification System”; U.S. Pat. No. 7,142,699 to Reisman et al., titled “Fingerprint Matching Using Ridge Feature Maps”; U.S. Pat. No. 6,226,391 to Dydyk et al., titled “Fingerprint Classification Via Spatial Frequency Components“; U.S. Pat. No. 5,960,101, to Lo et al., titled “Expert Matcher Fingerprint System”; and Published U.S. Patent application 2003/0039382 of Yau et al., titled “Fingerprint Recognition System.” However, nothing herein shall be interpret to suggest that we have performed any search of the prior art. Furthermore, no admission is made that any information referred to herein is “prior art,” or is considered to be material to patentability in relation to the claims hereinbelow unless specifically designated as such.

It is generally accepted that no two fingerprints are identical. For this reason, fingerprints may be used to distinguish one person from another, identify or verify a person's identity, etc. In this regard, methods and systems have been developed to capture data about the structure of a fingerprint, namely the locations and patters of ridges and valleys forming the fingerprint. This data can be compared to enrolled or authenticated data, and if a match is found the identity of the bearer of the fingerprint may be determined.

Global fingerprint analysis forms one form of fingerprint verification. An enrollment process gathers multiple fingerprint images. These are stored in an enrollment database. Upon the proffering of a fingerprint by a user for authentication, the image of the proffered fingerprint is compared to the images in the enrollment database. The pattern of ridges and valleys may be compared for the entire fingerprint to ensure a high degree of certainty of match to an enrolled fingerprint.

In many applications, the number of enrolled or authenticated fingerprints is quite large and/or it is critical that the time taken to compare a proffered fingerprint to the database of enrolled or authenticated fingerprints must be minimized. Indexing techniques have been developed to accelerate this matching process. One indexing technique employs identifiable fingerprint features, referred to as minutiae, as the indexed features.

According to various embodiments, an enrollment process again gathers multiple fingerprint images. The ridge pattern for each enrolled fingerprint is detected and analyzed for minutiae, for example by using step-wise linear approximations of the ridges and looking for minutiae such as ridge intersections, bifurcations, discontinuities, etc. The locations of each minutia are recorded for a fingerprint in the form of a minutiae template. Upon a user proffering a fingerprint for matching, a similar minutiae extraction and template building process is performed for the proffered fingerprint, then the template for the proffered fingerprint is compared to the database of enrolled templates, in search of a matching template.

However, each of the prior methods for fingerprint verification have presented disadvantages or tradeoffs, such as:
Prior indexing methods which are based on indexing individual minutia have low discrimination power and low robustness.
Prior methods based on global fingerprint features (e.g., fingerprint class) have problems associated with construction of an accurate full fingerprint, such as with small image overlap (from the image capture process) and sensitivity to image distortion (from multiple sources).
Prior algorithms have low scalability—verification is slow for large databases and identification is resource expensive.
Prior methods do not provide for a single algorithm for identification and verification operating both under unlimited and restricted resources.

### SUMMARY

Accordingly, the present invention addresses these disadvantages by performing indexing on minutiae pairs. For each minutia in the fingerprint, a set of surrounding “neighborhood” minutiae is identified. In each neighborhood, each minutiae pair of central and neighboring minutiae is described by several features including (but not limited to) the spacing between the two minutiae in a pair, the difference of orientations of two minutiae and the angle between the orientation of the central minutia and a line connecting the two minutiae. From these minutiae pair features, a minutiae pair index is constructed.

One advantage of the minutiae pair indexing disclosed herein is improved discrimination power compared to methods based on individual minutiae. The minutiae pair is still a small-scale feature, and therefore it is robust against image distortion and works with small image overlaps and small images. Furthermore, a single algorithm works both for fingerprint identification and verification and is scalable in terms of required resources (memory, computation). Therefore, minutiae pair indexing significantly improves the speed of operation for both identification and verification.

The above is a summary of a number of the unique aspects, features, and advantages of the present invention. However, this summary is not exhaustive. Thus, these and other aspects, features, and advantages of the present invention will become more apparent from the following description and the appended drawings.

### DRAWINGS

In the drawings appended hereto like reference numerals denote like elements between the various drawings. While illustrative, the drawings are not drawn to scale. In the drawings:

FIG. 1 is a sample fingerprint illustrating minutiae and a minutia neighborhood.

FIG. 2 illustrates a minutiae feature set including distance between two minutiae in a pair, orientation differences of two minutiae, and angle differences between the orientation of the central minutia and the line connecting the two minutiae.

FIGS. 3 and 4 illustrate minutiae pair indices used as identification keys for fast selection of an original fingerprint neighborhood.

FIG. 5 is a flow chart illustrating one embodiment of a method of employing minutiae pair indexing for determining a match between a proffered fingerprint and a reference print.

### DESCRIPTION

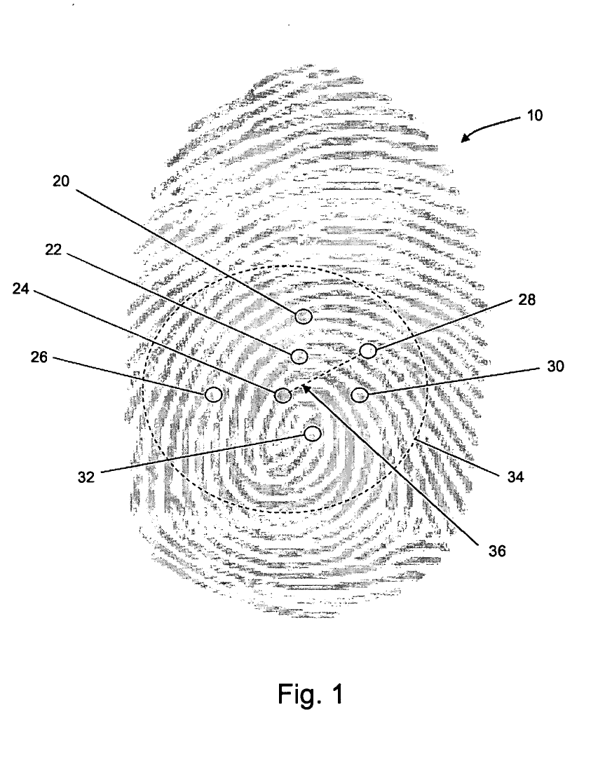

FIG. 1 illustrates a sample fingerprint 10, on which a number of minutia points 20-32 have been identified and indicated. It will be well understood that many different types of minutiae may be identified and used in the present invention, such as points of bifurcation 20-24, and/or discontinuity 26-32. Once identified, for example by methods well known in the art, each minutia may be represented by its position and orientation.

Shown in FIG. 1 is a circular region 34 we refer to as a “neighborhood,” within which there are located two or more minutiae. Each neighborhood is centered around a central minutia, for example minutia 24 of FIG. 1. While the shape of the neighborhood is not critical, the notion is that within some finite region around a central minutia there will be at least one additional minutia, for example minutia 28 of FIG. 1. The central minutia and the additional minutia within the neighborhood create a minutiae pair, discussed further below. Also shown in FIG. 1 is a constructed line 36 joining each of the minutiae pair. Line 36 is used in measuring the distance between the two minutiae 24, 28 for characterizing the minutiae pair, and is discussed in further detail below.

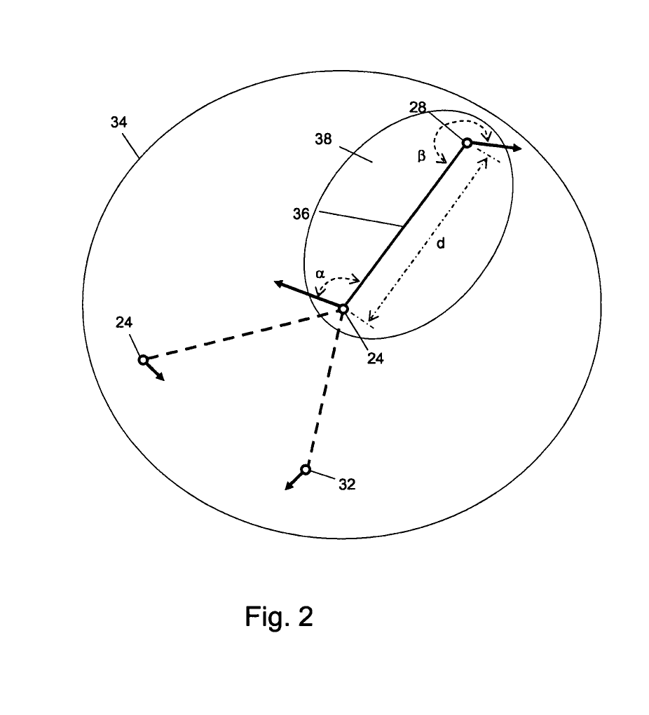

FIG. 2 is a more detailed view of the exemplary neighborhood 34, a number of the minutiae contained therein, as well as a specific minutiae pair 38. It will be appreciated that the average fingerprint will contain from several to many neighborhoods and minutiae pair, and the discussion herein of one such neighborhood and minutiae pair is merely illustrative of the analysis of each such minutiae pair. With reference to FIG. 2, in each neighborhood, each minutiae pair 38 comprised of central minutia 24 and neighboring minutia 28 can be uniquely characterized by a feature set. This feature set can include (but is not restricted to) the distance d between the two minutiae in the pair, the difference of orientations of the two minutiae (e.g., α+β−180), and the angle α between the orientation of the central minutia and the line connecting the two minutiae (Distance, Angle1 and Angle2). From these features, a minutia index is constructed. As used herein, the term “index” is intended to mean a set of data elements representing selected aspects of a minutiae pair. Furthermore, as used herein the term “index table” is intended to mean the data structure used for organizing and storing/obtaining data representing selected aspects of a minutiae pair using an index as a unique identifier (key). Further still, as used herein, “indexing” is intended to mean using an index and an index table for storing and lookup of data representing selected aspects of a minutiae pair.

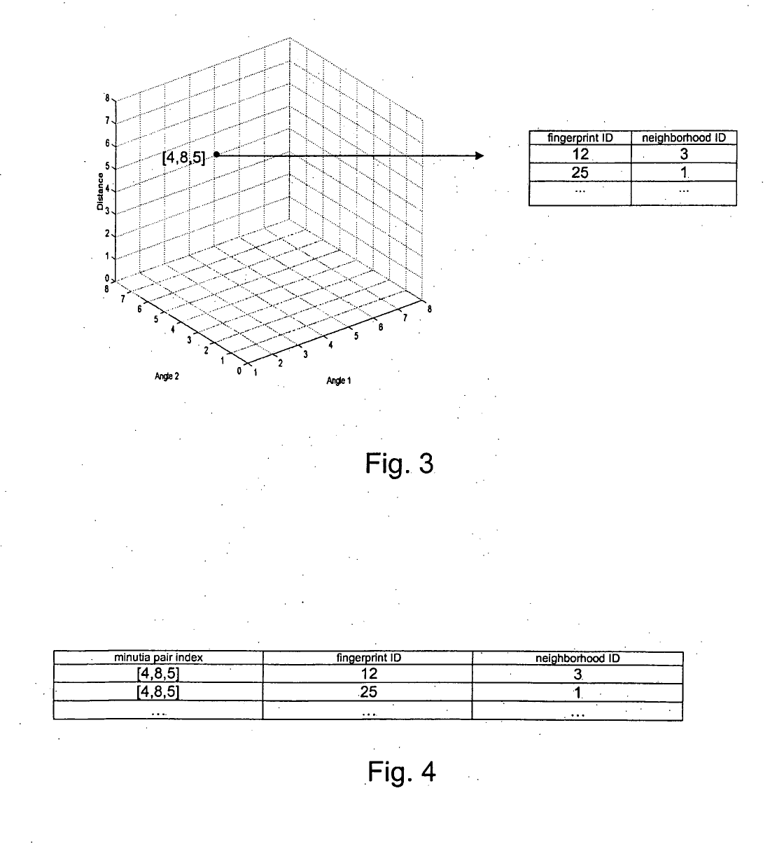

Each fingerprint will have a plurality of minutiae pair for which an index may be determined. Each minutiae pair will have a plurality of data elements comprising the index. Therefore, an index table is well suited for organizing the data elements, minutiae pair (identified by a pair ID), and fingerprints (identified by a fingerprint ID). For each minutiae pair index (i.e., for each minutiae pair from each neighborhood from each fingerprint), a minutiae pair membership is stored (e.g., neighborhood and fingerprint ID from which the minutiae pair originated). The minutiae pair index is used as an identification key for a fast selection of the original fingerprint neighborhood. FIGS. 3 and 4 illustrates one of many possible implementations of such a minutiae pair index.

Minutiae pair indexing can be effectively used to determine if a proffered fingerprint corresponds to an enrolled fingerprint. Such a process is common in verifying a user's identify to permit (or deny) access to a facility, files stored on a computer or network, to permit use of a cell phone, etc. One embodiment of a fingerprint identification/verification algorithm according to the present invention consists of the following main steps:
1. Construction of index table. Create the minutiae pair index for each minutia pair in each minutia neighborhood from one or more fingerprints and store the minutia membership in the index table. The table then contains the minutiae index data elements for the enrolled fingerprints.
2. Selection of matching minutia neighborhood. For a proffered fingerprint, which should be compared against the fingerprint(s) stored in the index table, create the minutiae pair index for each minutia in each minutia neighborhood, and select the minutiae pairs (if any) with the same index from the index table. Evaluate the number of selected matching minutiae pairs per neighborhood and decide if the neighborhood is matching.
3. Verification of matching minutia neighborhood. The found minutia neighborhoods may optionally be verified by a detailed comparison.
4. Selection of matching fingerprint(s). Evaluate the number of verified matching minutia neighborhoods for each indexed fingerprint and decide if the fingerprint is matching.

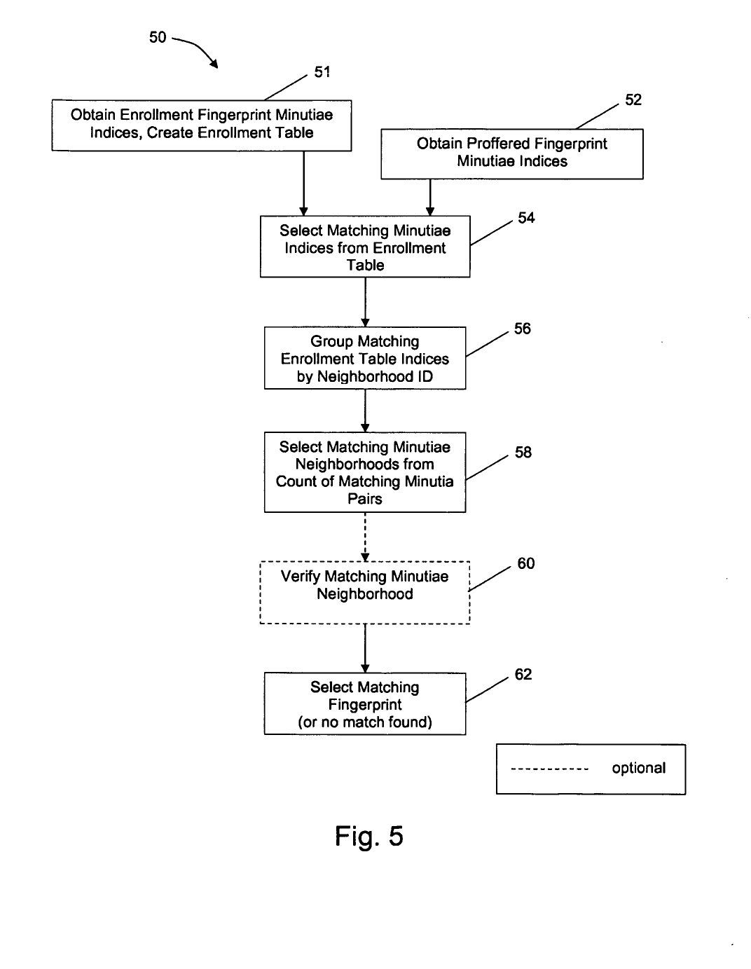

A process 50, representing one embodiment of the above, is illustrated in FIG. 5. Process 50 typically begins with the scanning of one or more fingerprints which shall serve as the enrolled fingerprints. In essence, proffered fingerprints are compared to the enrolled fingerprints (using the indexing processes described herein). A match between the proffered fingerprint and one of the enrolled fingerprints can be used for many purposes, such as identity verification, granting access to a facility or computer files, etc. At step 51, the index of all minutiae pairs from all minutia neighborhoods from one or more enrolled fingerprints is constructed and all these minutiae pairs represented by their fingerprint identification number and minutia neighborhood identification number are stored in the index table. An example of the data structure may be [fingerprint ID, Neighborhood ID, index] where index is the data structure [distance, angle1, angle2], although many other such data structures are possible and the actual format of the data structure does not limit the scope of the present invention. The fingerprint identification number can be, for example, the number from 1 to the number of indexed fingerprints and the minutia neighborhood identification number can be, for example, the number from 1 to the number of minutiae in the fingerprint. There is a strong correspondence between features characteristic for the proffered minutiae pair and the minutiae pair index which is used for fast matching minutiae pair selection.

At step 52, data representing a scanned, proffered fingerprint is obtained (e.g., from a fingerprint scanning device). While the enrollment of fingerprint data is typically done only one per fingerprint, scanned proffered data is obtained each time a user wishes to be authenticated for access, etc.

For the proffered fingerprint which should be compared against the fingerprint(s) in the index table, the minutiae pair index is created for each minutia in each minutia neighborhood. The minutiae pairs having the same index are then selected from the index table at step 54. Importantly, this is a relatively fast process, as the total population of index values is relatively small compared to, for example, the totality of data representing a fingerprint image.

For each minutiae neighborhood of the proffered fingerprint, the selected minutiae pairs are grouped by their fingerprint identification number and their minutia neighborhood identification number at step 56. A count is then made of the minutiae in each group. Each group contains the matching minutiae pairs from the corresponding minutia neighborhood of the corresponding fingerprint from which the minutiae pair stored in the index table originated.

An appropriate threshold is then chosen for the number of matching minutiae pairs for two minutia neighborhoods to be considered matching. The found minutia neighborhoods are selected as groups when the number of found minutiae pairs is greater than the chosen threshold, at step 58.

The correspondence of the proffered fingerprint's neighborhood and the found minutia neighborhood may be verified at step 60 by a detailed comparison of corresponding minutiae pairs. While optional, this verification provides significantly enhanced accuracy in the identification/verification process. Verification can be accomplished by constructing a new detail index table from the minutia neighborhood identified in step 2. The detail index table contains only the minutiae pairs from the identified minutia neighborhood, and the stored minutiae pairs are represented only by their minutia pair identification number. The minutia pair identification number can be, for example, the number from 1 to the number of neighboring minutiae in the neighborhood. The minutiae pair index is used for fast matching minutiae pair selection.

The minutiae pair indices from the proffered fingerprint's neighborhood are used for a selection of matching minutiae pairs from the detail index table. This selection reveals the concrete minutiae pair correspondence. The roles of the proffered and identified minutiae neighborhoods can be interchanged, i.e., the detail index table can be constructed from the proffered minutiae neighborhood whereas the minutiae pair indices from the identified minutiae neighborhood are used for a selection of matching minutiae pairs from the detail index table.

As an alternative to creating the new detail index table, one extended index table may be constructed in advance during step 1, which includes the minutiae pair identification number with the stored minutiae pair representation. The minutiae pairs are then represented by their fingerprint identification number, minutia neighborhood identification number, and minutiae pair identification number. The minutiae pair indices from the new fingerprint's neighborhood are used for a selection of matching minutiae pairs from the extended index table, but only those minutiae pairs that originated from the neighborhood found in step 2 are taken into account (i.e., the minutiae pairs that are represented by the same fingerprint identification number and minutia neighborhood identification number as the minutia neighborhood found in step 2). This selection reveals the concrete minutiae pair correspondence. (An alternative is to pre-select the matching minutiae pairs from the extended index table during step 2.)

The similarity of the corresponding minutiae pair may be verified by a direct minutiae pair difference comparison in full precision (e.g., direct computation of difference of minutiae pair features). The number of verified matching minutiae pairs are then determined for a found minutia neighborhood. The minutia neighborhoods with the number of found and verified minutiae pairs greater than a chosen threshold are selected, and the identification numbers of corresponding minutia neighborhoods are stored.

Finally, the number of verified matching minutia neighborhoods are evaluated, and a decision is made as to whether the proffered fingerprint matches the fingerprint whose data is stored in the index table at step 62. The verified matching minutia neighborhoods selected in step 3 are grouped by their fingerprint identification number. Each group contains the verified matching minutia neighborhoods from the corresponding fingerprint from which the minutiae pair stored in the index table originated. The number of verified matching minutia neighborhoods in each group are evaluated. An appropriate threshold is chosen for the number of matching minutia neighborhoods for two fingerprints to be considered matching, and the matching fingerprints are selected as groups with the number of verified matching minutia neighborhoods greater than the chosen threshold.

The steps described above can be used both for fast fingerprint identification and verification, as follows.

Fingerprint identification by index table created from many fingerprints. All minutiae pairs from all minutia neighborhoods from all enrolled fingerprints are indexed and stored in the index table. The fingerprint(s) matching with the new fingerprint is selected from the index table by its minutiae pair indices.

Fingerprint identification by index table created from one fingerprint. All minutiae pairs from all minutia neighborhoods from the new fingerprint are indexed and stored in the index table. All enrolled fingerprints are compared with the new fingerprint by selection from the index table by their minutiae pair indices.

Fingerprint verification. All minutiae pairs from all minutia neighborhoods from one fingerprint are indexed and stored in the index table. The second fingerprint is compared with the first fingerprint by selection from the index table by its minutiae pair indices.

Refinement of index construction. In order to find the matching minutiae pair from the index table both the proffered minutiae pair and the matching minutiae pair stored in the index table must have equal minutiae pair index. This is achieved by constructing the minutiae pair index for all feature values which are within a chosen tolerance of the minutiae pair feature. Each minutiae pair can then have multiple indices whose count depends on chosen tolerance. The multiple minutiae pair indices can be used either during construction of the index table where the minutiae pair representation is stored in the index table multiple times for all its different indices or alternatively the multiple indices can be used during selection of the minutiae pair from the index table by repetitive minutiae pair selection by all its different indices.

While a plurality of preferred exemplary embodiments have been presented in the foregoing detailed description, it should be understood that a vast number of variations exist, and these preferred exemplary embodiments are merely representative examples, and are not intended to limit the scope, applicability or configuration of the invention in any way. Rather, the foregoing detailed description provides those of ordinary skill in the art with a convenient guide for implementation of the invention, by way of examples, and contemplates that various changes in the functions and arrangements of the described embodiments may be made without departing from the spirit and scope of the invention described herein.

What is claimed is:

1. A method of determining whether first fingerprint data and second fingerprint data match one another, comprising:
creating a minutia neighborhood around each minutia in each of said first and second fingerprint data, such that each neighborhood includes a central minutia and at least a second minutia which, together with the central minutia, comprise a minutiae pair;
creating an index of characteristics of said minutia pair for each of said first and second fingerprint data;
for each index in said first fingerprint data, identifying a matching index in said second fingerprint data, if any, as well as the neighborhood associated with said index in both said first and second fingerprint data;
counting all said matching indices in said identified neighborhood, and if the number of matching indices is at least equal to a threshold value, characterizing said neighborhoods from said first and second fingerprint data as matching; and
counting the number of matching neighborhoods between the first and second fingerprint data, and if the number of matching neighborhoods is at least equal to a threshold value, characterizing said first and second fingerprint data as matching.

2. The method of claim 1, wherein said index comprises at least one value representing characteristics selected from the group consisting of:
the difference in orientation between the two minutiae of said minutiae pair;
the angle between the orientation of one of said minutiae and a line connecting the two minutiae; and
the distance between each minutia of said minutiae pair.

3. The method of claim 1, wherein the indication of a match between neighborhoods from said first and second fingerprint data is verified by a detailed comparison of the first and second fingerprint data for said neighborhoods prior to said step of counting the number of matching neighborhoods.

4. A method for determining if a proffered fingerprint matches one which has previously been enrolled and stored in an enrollment database, comprising:
determining, from data representing the proffered fingerprint, the locations of minutiae within the fingerprint;
for each minutia, and with each said minutia as a central minutia, establishing around said minutia a minutia neighborhood, said minutia neighborhood sized such that said minutia neighborhood includes said central minutia and at least one other minutia forming a minutiae pair;
assigning said minutia neighborhood a neighborhood id
determining for each minutiae pair in said neighborhood selected characteristics;
creating an index representing said selected characteristics;
associating said index and said neighborhood id so as to uniquely identify said minutiae pair;
for each index representing selected characteristics of a minutiae pair, selecting from said enrollment database those minutiae pair, if any, having the same index;
sorting said matching indices from said enrollment database by neighborhood id;
determining if said number of matching indices from said enrollment database is at least equal to a threshold number, and if so, identifying the fingerprint or fingerprints from said enrollment database within which said neighborhood may be found, and further categorizing said neighborhood as a matching neighborhood;
for each identified fingerprint from the enrollment database, counting the number of matching neighborhoods; and
determining from at least a count of the number of matching neighborhoods whether there is a match between the proffered fingerprint and a fingerprint contained in the enrollment database.

5. The method of claim 4, wherein said index comprises at least one value representing characteristics selected from the group consisting of:
the difference in orientation between the two minutiae of said minutiae pair;
the angle between the orientation of one of said minutiae and a line connecting the two minutiae; and
the distance between each minutia of said minutiae pair.

6. The method of claim 4, wherein the indication of a match between neighborhoods is verified by a detailed comparison of the proffered fingerprint data for said neighborhoods and data from the enrollment database for said neighborhoods prior to said step of counting the number of matching neighborhoods.

7. A method for identifying and/or verifying proffered fingerprint data by comparing said proffered fingerprint data to data stored in an enrollment database relating to at least one enrolled fingerprint having a fingerprint identification number, comprising the steps of:
representing a proffered fingerprint by proffered fingerprint data;
determining, from the proffered fingerprint data, locations and characteristics for minutiae in said proffered fingerprint;
for each minutia in said proffered fingerprint, determining a neighborhood, with each said minutia being a central minutia for that neighborhood, and further where each said neighborhood comprises at least one minutiae pair including said central minutia;
assigning each neighborhood a neighborhood identification;
determining minutiae pair indices for each minutiae pair in each neighborhood;
creating, for each minutia neighborhood of the enrolled fingerprint, a minutiae pair index table of minutiae pair indices;
selecting minutiae pairs from said enrollment database having the same minutiae pair indices as those determined from the proffered fingerprint data;
grouping the selected minutiae pairs by their fingerprint identification number and their minutia neighborhood identification number;
counting the minutiae in each group;
identifying, from said minutiae count, which enrolled fingerprints in the enrollment database may constitute matches with the proffered fingerprint;
for each identified fingerprint in the enrollment database which may constitute a match with the proffered fingerprint, counting the number of minutiae neighborhoods in each said identified fingerprint which match a minutiae neighborhood in the proffered fingerprint; and
determining, from a count of the number of matching minutiae neighborhoods, whether the proffered fingerprint matches a fingerprint enrolled in the enrollment database.

8. The method of claim 7, wherein said minutia index comprises at least one value representing characteristics selected from the group consisting of:
the difference in orientation between the two minutiae of said minutiae pair;
the angle between the orientation of one of said minutiae and a line connecting the two minutiae; and
the distance between each minutia of said minutiae pair.

9. The method of claim 7, further comprising the step of verifying the determined match by a detailed comparison of corresponding minutiae pairs.

10. The method of claim 7, wherein said step of identifying, from said minutiae count, which enrolled fingerprints in the enrollment database may constitute matches with the proffered fingerprint comprises determining whether said minutiae count is at least equal to a predetermined minutiae pair threshold.

11. The method of claim 7, wherein said step of determining, from a count of the number of matching minutiae neighborhoods, whether the proffered fingerprint matches a fingerprint enrolled in the enrollment database comprises determining whether said count of the number of matching minutiae neighborhoods is at least equal to a predetermined minutiae neighborhoods threshold.
